(19) United States
(12) Patent Application Publication
(10) Pub. No.: US 2005/0114405 A1
(43) Pub. Date: May 26, 2005

(54) Flat file processing method and system

(75) Inventor: Wei-Lun Lo, Issaquah, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation

(21) Appl. No.: 10/721,663

(22) Filed: Nov. 25, 2003

(51) Int. Cl. G06F 7/00

(52) U.S. Cl. 707/200

(57) ABSTRACT

Parsing and serializing files is performed to effect desired file conversions in a workflow. A method of parsing includes receiving a flat file in a native format, translating native format characters into tokens, and converting the flat file to an XML format with the use of an annotated schema. The annotated schema may include a model of the flat file inclusive of both delimited and positional types. A method of serializing includes receiving an XML file and converting it to a native format. A model of the native format may be used for serializing to produce a proper flat file format.

### FIELD OF THE INVENTION

The invention relates generally to the field of business process automation and more specifically to the conversion of flat files between native and XML format for purposes of file transfer in a business environment.

### BACKGROUND OF THE INVENTION

Business procedures have typically been automated using a business procedures processor running a model of the business process. This model is the workflow process. The business forms used in transactions such as purchase orders and loan applications vary widely between organizations within a business as well as between differing businesses. As a result, the format of the documents which flow between business entities have varied. Recently, the extensible markup language (XML) which is a world wide web consortium (W3C) standard has gained popularity for expressing business documents in a standardized format. Innovations such as Biz Talk™ from Microsoft Corporation (One Microsoft Way, Redmond, Wash. 98052) have introduced the idea that a business workflow processor can orchestrate business transactions using the XML standard to accomplish document transfers in the course of daily business.

However, legacy forms, or existing forms as well as some other fixed format documents, may be converted into an XML format before the document arrives at the business workflow processor. Therefore, a conversion from the received documents native format to the standardized XML format is generally needed. Moreover, this conversion has typically been accomplished by custom coding by a programmer to accommodate the native format specific to the received documents in question. This custom approach may be expensive in the utilization of resources and may involve a time delay in the execution of a workflow when a newly-formatted document arrives.

Thus, there is a need for a method and system which can perform a conversion between a native flat file format and a standardized XML format without involving a programmer's resources. The present invention addresses the aforementioned needs and solves them with additional advantages as expressed herein.

### SUMMARY OF THE INVENTION

Conversion of a flat file to an XML file and the reverse is described. An exemplary method includes receiving a flat file in a native format and parsing the flat file to produce an XML file by converting the file format with the use of at least one annotated schema. The flat file format may be a file using tags and delimiters to identify and separate, respectively, data in the file. The annotated schema includes a model of the flat file which may describe the delimited and positional characteristics of the flat file. The reverse process of converting an XML file to a flat file may be performed by serializing the XML file using the flat file characteristics.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 illustrates a block diagram of an exemplary embodiment of a parsing system in accordance with the present invention; and

FIG. 3 illustrates a block diagram of an exemplary embodiment of a serializing system in accordance with the present invention.

### DETAILED DESCRIPTION OF ILLUSTRATIVE EMBODIMENTS

Overview

Conversion between a native flat file format and the XML standard using annotated schemas is described. A user may thus easily convert, for example, a native flat file into a specific XML format so that a business workflow processor may transfer the converted document as part of the business workflow. A reversal of the technique is also described as it may be desirable to transmit a native document to a business entity who accepts only a native flat file format, for example.

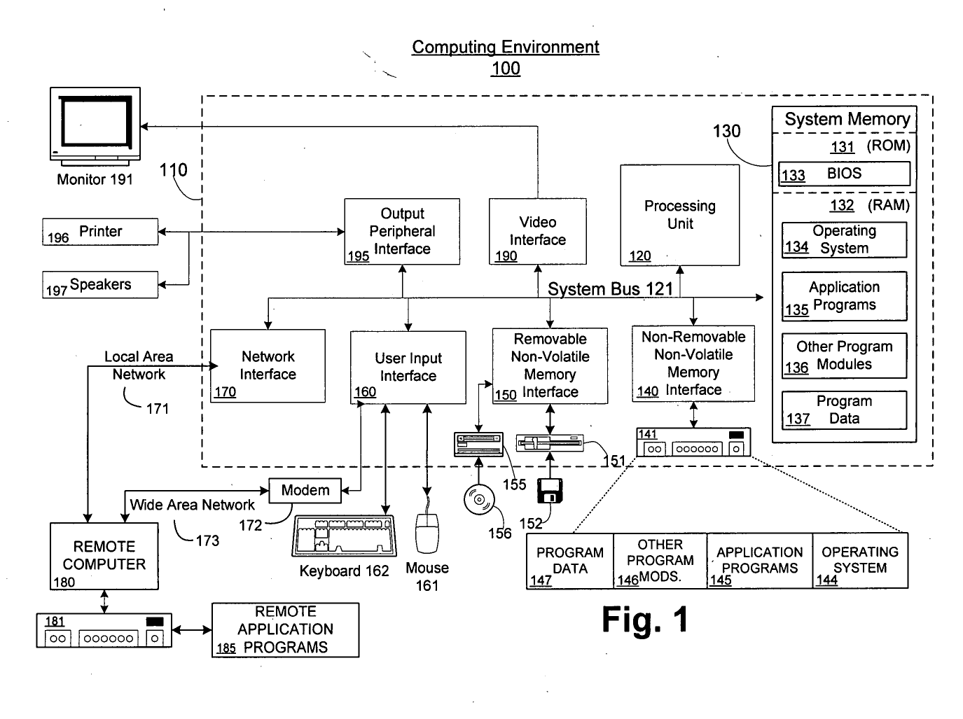

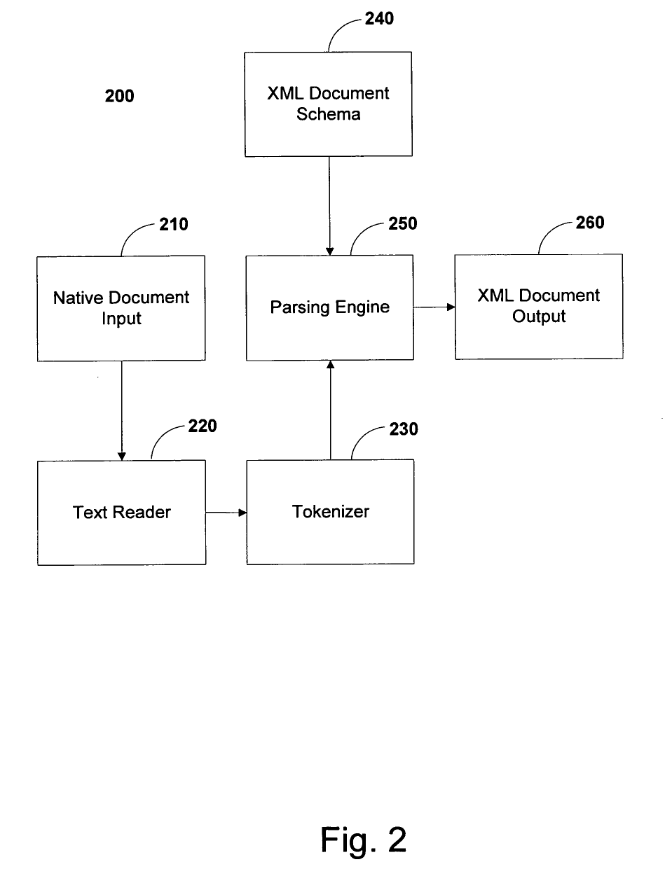

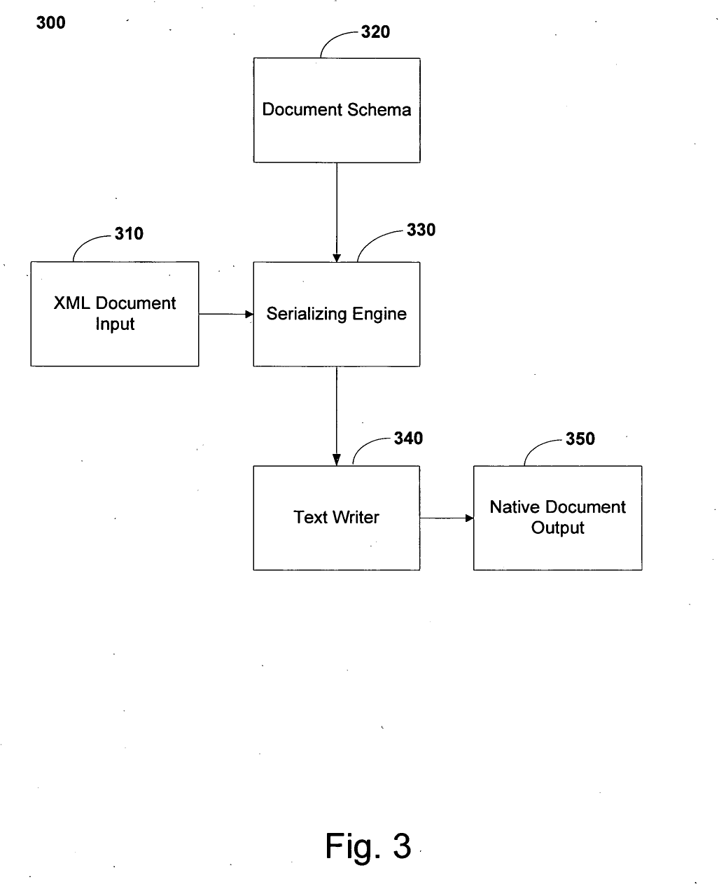

After discussing an exemplary computing environment in conjunction with FIG. 1 in which the invention may be practiced, exemplary embodiments will be discussed in conjunction with FIGS. 2 and 3.

Exemplary Computing Device

FIG. 1 and the following discussion are intended to provide a brief general description of a suitable computing environment in which the invention may be implemented. It should be understood, however, that handheld, portable and other computing devices and computing objects of all kinds are contemplated for use in connection with the invention. Thus, while a general purpose computer is described below, this is but one example, and the invention may be implemented with other computing devices, such as a client having network/bus interoperability and interaction. Thus, the invention may be implemented in an environment of networked hosted services in which very little or minimal client resources are implicated, e.g., a networked environment in which the client device serves merely as an interface to the network/bus, such as an object placed in an appliance, or other computing devices and objects as well. In essence, anywhere that data may be stored or from which data may be retrieved is a desirable, or suitable, environment for operation according to the invention.

Although not required, the invention can be implemented via an operating system, for use by a developer of services for a device or object, and/or included within application software that operates according to the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer system 110. Components of computer system 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer system 110 typically includes a variety of computer readable media. Computer readable media can be any available media that can be accessed by computer system 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by computer system 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer system 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer system 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM, CDRW, DVD, or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer system 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer system 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190, which may in turn communicate with video memory (not shown). In addition to monitor 191, computer systems may also include other peripheral output devices such as speakers 197 and printer 196, which may be connected through an output peripheral interface 195.

The computer system 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer system 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer system 110 is connected to the LAN 171 through a network interface or adapter 170. When used in a WAN networking environment, the computer system 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer system 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET™ platform, available from Microsoft Corporation, includes servers, building-block services, such as Web-based data storage, and downloadable device software. While exemplary embodiments herein are described in connection with software residing on a computing device, one or more portions of the invention may also be implemented via an operating system, application programming interface (API) or a “middle man” object between any of a coprocessor, a display device and a requesting object, such that operation according to the invention may be performed by, supported in or accessed via all of .NET™'s languages and services, and in other distributed computing frameworks as well.

Exemplary Embodiments of the Invention

FIG. 2 depicts a block diagram of an exemplary embodiment of a parsing system 200 that permits conversion of non-XML flat files to XML files without user-written code. A native, non-XML document can be input 210 into the system. A text reader 220 may be responsible for normalizing the raw native document input 210 from various encoding mechanisms such as unicode transformation format (UTF-8), American National Standards Institute (ANSI), and multi-byte character set (MBCS) into Unicode. The text reader may support additional formats conversions, for example, from Extended Binary Coded Decimal Interchange Code (EBCDIC) to Unicode.

The tokenizer 230 inputs and converts input characters into meaningful tokens such as tag, delimiter and value. The tokenizer 230 may recognize tokens based on the information in the record or field definitions of the non-XML document. Generally, non-XML documents may be classified according to the format of their information. Non-XML flat files may be either of the delimited or positional type, for example.

The parsing engine 250 takes the normalized data from the tokenizer and determines a format for the converted document. If the format is to be of a specific schema, then the parsing engine 250 may be a schema-driven parsing engine which disassembles the native document information. In that event, the document schema 240 may provide a custom schema for parsing of the input document. In the event there is no specific schema selected, the parsing engine 250 accepts the tokens from the tokenizer 230 and processes it to a XML form using parsing instructions contained in XML schema 240. The parser engine may also support streaming so that large documents may be efficiently processed. In one embodiment, it may be desirable that the parser 250 have a well defined extensibility model such that third party developers may customize the engine. The final result of this process is a business document in XML format 260 produced by the Parsing Engine 250.

There are two kinds of data elements in a flat file document: record and field. A record is a container of fields or other records. A field is a terminal (i.e. non-container) node that contains data. A record can optionally contain a tag. However it is desirable to have tags at the beginning of a record to help resolve ambiguities and gain efficiency at parsing time.

Exemplary embodiments of the present invention process flat files into XML files and may be useful for two kinds of flat file record types; delimited records and positional records. Delimited records are composed of containers that have delimiters that separate the items within the record. For example, a record containing comma-separated values is a delimited record with commas as the delimiters. Delimiters may include one or more characters, and any character, regardless of validity in XML, can be all or part of a delimiter because delimiters are removed prior to storage as an XML document in accordance with the present invention. Positional records do not rely on delimiters to separate items with the record; rather, they rely on the relative character position of each item to determine their meaning. For instance, a positional employee record may dictate that positions 1 to 10 contains an employee ID and positions 11 to 30 contain an employee name.

Generally, there will be a new delimiter at each level of record nesting. The delimiter may change at each level, but the same delimiter may be present at different levels as long as there is at least one different intervening delimiter. In a non-XML document which uses delimiters, the order of the delimiter with respect to the data field generally has one of three possible formats. The first format for non-XML data is called a prefix type format in which the data tag (Tag) precedes the delimiter (*) and the data field (field) as follows:
prefix type format: (e.g., Tag*field1*field2);

The second format for non-XML data is called a infix type format in which the data tag (Tag) and data field (field) precede the delimiter (*) such that the delimiter is in the middle of the format between data fields and may be described as follows:
infix type data format: (e.g., Tagfield1*field2)
   This infix type data format always has one less delimiters than the number of fields.

The third format for non-XML data is called a postfix type format in which a delimiter (*) is placed after the fixed field and may be described as follows:
postfix type data format: (e.g., “Tagfield1*field2*)

It is possible to mix record types in one single flat file. A delimited record can contain other delimited records, positional records or fields. However, a positional record cannot contain delimited records because delimited records are variable-length by nature which will thwart the relative positions of child items.

By using annotated schemas as part of the non-XML to XML conversion process, a user may not have to generate code in order to read non-XML files and convert them into an XML format. The flexible annotated schemas of the present invention provide this capability. Also, a user interface may be generated such that graphical means may be used to provide a target flat file structure example. In this case, the user interface may generate the actual schema annotation code for the specified flat file without the user generating code.

An example of an instance of the present invention is the conversion of a non-XML document using an annotated schema into an XML document. The annotated XML schema may be used to automatically parse the non-XML document. Given a document with data in fields of the form:
f1, f2, f3

where f1, f2, and f3 are fields of data separated by commas used as delimiters, an annotated schema may be as follows:

```
<xsd:schema xmlns:xsd=”http://www.w3.org/2001/XMLSchema”
xmlns:b=“http://schemas.microsoft.com/BizTalk/2003” >
    <xsd:element name=”record” />
        < xsd:annotation>
        < xsd:appinfo>
            <b:recordinfo structure=”delimited” delimiter=’,’/>
        </ xsd:appinfo>
        </ xsd:annotation>
        < xsd:complexType>
        < xsd:sequence>
            <xsd:element name = “n1” type= “string”/>
            <xsd:element name = “n2” type = “string”/>
            <xsd:element name = “n3” type = “string”/>
        </ xsd:sequence>
        </ xsd:complexType>
    </xsd:element name = “document”>
</xsd:schema>
```

The application information statements <appinfo> contain the specific information needed to extract the data in fields “n1”, “n2” and “n3”, which are comma separated field values and place them into an XML document. In brief, the resultant XML document may have the form as follows:

```
<record>
        <n1> f1 </n1>
        <n2> f2 </n2>
        <n3> f3 </n3>
</record>
```

An additional example of full code using annotated schemas to parse a non-XML document is provided as follows:

```
<?xml version=“1.0” encoding=“utf-16”?>
<xs:schema xmlns=“http://BizTalk_Server_Project2.Sample”
xmlns:b=“http://schemas.microsoft.com/BizTalk/2003”
targetNamespace=“http://BizTalk_Server_Project2.Sample”
xmlns:xs=“http://www.w3.org/2001/XMLSchema”>
  <xs:annotation>
    <xs:appinfo>
      <b:schemaInfo count_positions_by_byte=“false” standard=“Flat File” root_reference=“Root”
/>
      <schemaEditorExtension:schemaInfo namespaceAlias=“b”
extensionClass=“Microsoft.BizTalk.FlatFileExtension.FlatFileExtension” standardName=“Flat
File”
xmlns:schemaEditorExtension=“http://schemas.microsoft.com/BizTalk/2003/SchemaEditorExtensions”
/>
    </xs:appinfo>
  </xs:annotation>
  <xs:element name=“Root”>
    <xs:annotation>
      <xs:appinfo>
        <b:recordInfo structure=“delimited” suppress_trailing_delimiters=“false”
sequence_number=“1” child_delimiter_type=“hex” child_delimiter=“0x0D 0x0A” />
      </xs:appinfo>
    </xs:annotation>
    <xs:complexType>
      <xs:sequence>
        <xs:annotation>
          <xs:appinfo>
            <b:groupInfo sequence_number=“0” />
          </xs:appinfo>
        </xs:annotation>
        <xs:element name=“DelimitedRecord”>
          <xs:annotation>
            <xs:appinfo>
              <b:recordInfo structure=“delimited” suppress_trailing_delimiters=“false”
sequence_number=“1” child_delimiter_type=“char” child_delimiter=“,” />
            </xs:appinfo>
          </xs:annotation>
          <xs:complexType>
            <xs:sequence>
              <xs:annotation>
                <xs:appinfo>
                  <b:groupInfo sequence_number=“0” />
                </xs:appinfo>
              </xs:annotation>
              <xs:element name=“Field1” type=“xs:string”>
                <xs:annotation>
                  <xs:appinfo>
                    <b:fieldInfo sequence_number=“1” justification=“left” />
                  </xs:appinfo>
                </xs:annotation>
              </xs:element>
              <xs:element name=“Field2” type=“xs:string”>
                <xs:annotation>
                  <xs:appinfo>
                    <b:fieldInfo sequence_number=“2” justification=“left” />
                  </xs:appinfo>
                </xs:annotation>
              </xs:element>
            </xs:sequence>
          </xs:complexType>
        </xs:element>
        <xs:element name=“Positional”>
          <xs:annotation>
            <xs:appinfo>
              <b:recordInfo sequence_number=“2” structure=“positional”
suppress_trailing_delimiters=“false” />
            </xs:appinfo>
          </xs:annotation>
          <xs:complexType>
            <xs:sequence>
              <xs:annotation>
                <xs:appinfo>
                  <b:groupInfo sequence_number=“0” />
                </xs:appinfo>
              </xs:annotation>
              <xs:element name=“Field4” type=“xs:string”>
                <xs:annotation>
                  <xs:appinfo>
                    <b:fieldInfo sequence_number=“2” justification=“left” pos_length=“5” />
                  </xs:appinfo>
                </xs:annotation>
              </xs:element>
            </xs:sequence>
            <xs:attribute name=“Field3” type=“xs:string”>
              <xs:annotation>
                <xs:appinfo>
                  <b:fieldInfo sequence_number=“1” justification=“left” pos_length=“5” />
                </xs:appinfo>
              </xs:annotation>
            </xs:attribute>
          </xs:complexType>
        </xs:element>
      </xs:sequence>
    </xs:complexType>
  </xs:element>
</xs:schema
```

The example above is illustrative of an XML annotated schema having aspects of the present invention which may convert both positional as well as delimited type non-XML files into XML files. Specifically, the example illustrates how the annotated schemas may provide the delimited or positional extraction techniques to identify the data within a non-XML document. For example the first such annotation from the above example is:

```
  <xs:annotation>
    <xs:appinfo>
      <b:schemaInfo count_positions_by_byte=“false” standard=“Flat File” root_reference=“Root” />
      <schemaEditorExtension:schemaInfo namespaceAlias=“b”
extensionClass=“Microsoft.BizTalk.FlatFileExtension.FlatFileExtension” standardName=“Flat File”
xmlns:schemaEditorExtension=“http://schemas.microsoft.com/BizTalk/2003/SchemaEditorExtensions” />
    </xs:appinfo>
  </xs:annotation>
```

This schema-level annotation describes a schema info annotation that allows a flat file dissembler to count positions by bytes for positional fields in order to perform part of a document conversion.

The second schema annotation described in the example above is:

```
  <xs:annotation>
    <xs:appinfo>
      <b:recordInfo structure=“delimited” suppress_trailing_{—}
delimiters=“false” sequence_number=“1” child_delimiter_type=“hex”
child_delimiter=“0x0D 0x0A” />
    </xs:appinfo>
  </xs:annotation>
```

This record-level annotation describes a structure for a positional or delimited native file type of record. In one embodiment, the default value may be delimited except when the parent record may be positional, in which case the default may be positional.

The third schema annotation described in the example above is:

```
<xs:annotation>
  <xs:appinfo>
    <b:groupInfo sequence_number=“0” />
  </xs:appinfo>
</xs:annotation>
```

This group-level annotation describes a sequence number wherein the number represents the position with respect to the number's immediate parent.

The fourth schema annotation described in the example above is:

```
        <xs:annotation>
          <xs:appinfo>
            <b:recordInfo structure=“delimited” suppress_trailing_delimiters=“false”
sequence_number=“1” child_delimiter_type=“char” child_delimiter=“,” />
          </xs:appinfo>
        </xs:annotation>
```

This record-level annotation describes for a positional or delimited native file type of record.

The fifth schema annotation described in the example above is:

```
<xs:annotation>
  <xs:appinfo>
    <b:groupInfo sequence_number=“0” />
  </xs:appinfo>
</xs:annotation>
```

This group-level annotation describes a sequence number wherein the number represents the position with respect to the number's immediate parent.

The sixth schema annotation described in the example above is:

```
<xs:annotation>
  <xs:appinfo>
    <b:fieldInfo sequence_number=“1” justification=“left” />
  </xs:appinfo>
</xs:annotation>
```

This field-level annotation describes a sequence number wherein the number represents the position with respect to its immediate parent. Here, the field sequence number is 1. It also describes that the data to be left-justified.

The seventh schema annotation described in the example above is:

```
<xs:element name=“Field2” type=“xs:string”>
  <xs:annotation>
    <xs:appinfo>
      <b:fieldInfo sequence_number=“2” justification=“left” />
    </xs:appinfo>
  </xs:annotation>
```

This field-level annotation describes a sequence number wherein the number represents the position with respect to it's immediate parent. Here, the field sequence number is 2.

The eighth schema annotation described in the example above is:

```
  <xs:annotation>
    <xs:appinfo>
      <b:recordInfo sequence_number=“2” structure=“positional”
suppress_trailing_delimiters=“false” />
    </xs:appinfo>
  </xs:annotation>
```

This record-level annotation describes for a positional or delimited native file type of record.

The ninth schema annotation described in the example above is:

```
<xs:annotation>
  <xs:appinfo>
    <b:groupInfo sequence_number=“0” />
  </xs:appinfo>
</xs:annotation>
```

This group-level annotation describes a sequence number wherein the number represents the position with respect to the number's immediate parent.

The tenth schema annotation described in the example above is:

```
<xs:annotation>
  <xs:appinfo>
    <b:fieldInfo sequence_number=“2” justification=“left”
    pos_length=“5” />
  </xs:appinfo>
</xs:annotation>
```

This field-level annotation describes a sequence number wherein the number represents the position with respect to its immediate parent (a positional record).

The eleventh schema annotation described in the example above is:

```
<xs:annotation>
  <xs:appinfo>
    <b:fieldInfo sequence_number=“1” justification=“left”
    pos_length=“5” />
  </xs:appinfo>
</xs:annotation>
```

This field-level annotation describes a sequence number wherein the number represents the position with respect to its immediate parent.

Tables 1-5 below describe some additional or similar annotations that may be used in an embodiment of the present invention.

TABLE 1
Schema Info Annotations

| Name | Values available | Description |
|---|---|---|
| codepage | <list of code pages> | Contains a list of Code pages that are |
| | | currently supported |
| default_escape_char | character | Default escape character for the entire |
| | | schema |
| escape_char_type | Hexadecimal\| | |
| | Character\|None | |
| default_child_delimiter | string | Default child delimiter for the entire |
| | | schema. Size is limited to 10 characters. |
| child_delimiter_type | Hexadecimal\| | |
| | Character\|None | |
| default_repeating_delimiter | string | Default repeating delimiter for the entire |
| | | schema. Size is limited to 10 characters. |
| repeating_delimiter_{—} | Hexadecimal\| | |
| type | Character\|None | |
| count_positions_by_{—} | True\|False | Count positions by byte, if this is set to |
| byte | | true. |
| case | Upper\|Lower\| | Default - as-is, i.e., when case is not set. |
| | Default | Conversion to/from will be done in |
| | | Uppercase only if value is upper and to |
| | | lowercase if value is lower |
| default_child_order | Prefix\|Infix\|Postfix\| | Default - If tag!=NULL prefix, else |
| | Default | infix. |
| | | The default behavior can be overrode by |
| | | setting the default here. |
| default_wrap_char | character | Default wrap character for the entire |
| | | schema |
| wrap_char_type | Hexadecimal\| | |
| | Character\|None | |

TABLE 2
Group Info Annotations

| | Values | |
|---|---|---|
| Name | available | Description |
| sequence_number | number | A number that represents |
| | | the position with respect |
| | | to its immediate parent. |

TABLE 3
Record Info Annotations

| | Values | |
|---|---|---|
| Name | available | Description |
| All Records: | | |
| tag_name | string | Name of the tag for a record. |
| sequence_number | number | A number that represents the position with respect |
| | | to its immediate parent. |
| structure | Delimited\| | Indicates type of record |
| | Positional | |
| Positional | | |
| Records: | | |
| tag_offset | number | For positional records, tag may not start from 0. |
| | | This number indicates the start offset of the |
| | | record's tag relative to the previous sibling or |
| | | delimiter. |
| Delimited | | |
| Records: | | |
| child_order | Prefix\| | Indicates the relationship between delimiters and |
| | Postfix\|Infix\| | the things they delimit, persisted as “child_order” |
| | Default | Prefix indicates that the delimiter comes before the |
| | Child | data, postfix indicates a delimiter that follows the |
| | Order\| | data, and infix is for delimiters that sit between |
| | None | delimited things. Number of prefix and postfix |
| | | delimiters will equal the number of delimited |
| | | things, and infix delimiters will be equal to |
| | | delimited things - 1. |
| child_delimiter | String | Default child delimiter within a record. Size is |
| | | limited to 100 characters. |
| child_delimiter_type | Hexadecimal\| | |
| | Character\| | |
| | Default | |
| | Child | |
| | Delimiter\| | |
| | None | |
| escape_char | character | Escape character within a record. |
| escape_char_type | Hexadecimal\| | |
| | Character\| | |
| | Default | |
| | Escape | |
| | Character\| | |
| | None | |
| repeating_delimiter | string | Default repeating delimiter within a record. Size is |
| | | limited to 100 characters. |
| repeating delimiter_{—} | Hexadecimal\| | |
| type | Character\| | |
| | Default | |
| | Repeating | |
| | Delimiter\| | |
| | None | |
| suppress_trailing_{—} | True\| | Trailing delimiters can be suppressed if this is set |
| delimiters | False | to true. |
| | | This annotation applies to assemblers only. |
| preserve_delimiter_{—} | True\| | Default -> |
| for_empty_data | False\| | Fields - Empty fields will have delimiter |
| | Default | preserved. |
| | | Records - All child tagless records will have the |
| | | delimiter preserved. |
| | | Empty tagged records will not have the delimiter |
| | | preserved. |
| | | If set to True, the delimiter will be preserved for |
| | | both empty fields and empty records. |
| | | If set to False, the delimiter will not be preserved |
| | | for either empty fields or empty records. |
| | | This annotation applies to assemblers only. |

TABLE 4
Field Info Annotations

| | Values | |
|---|---|---|
| Name | available | Description |
| All Fields: | | |
| sequence_number | Number | A number that represents |
| | | the position with respect |
| | | to its immediate parent. |
| pad_char | character | Controls how padding characters |
| | | are either removed or added. |
| pad_char_type | Hexadecimal\| | |
| | Character\| | |
| | None | |
| datetime_format | Characters | Follow .Net Framework |
| | | Convert class for date time format. |
| | | Everything that is supported by |
| | | this class for date time format |
| | | will be supported for both |
| | | parsers and serializers. |
| justification | Left\|Right | Indicates what the |
| | | justification is for field content. |

TABLE 5
Positional and Delimited Fields

| | Values | |
|---|---|---|
| Name | available | Description |
| Positional Fields: | | |
| pos_offset | number | Starting offset of the |
| | | field relative to the |
| | | previous sibling |
| | | or delimiter. |
| pos_length | number | Field length from |
| | | the previous sibling |
| | | or delimiter |
| Delimited Fields: | | |
| min_length_with_pad | number | Controls how the |
| | | serializers pad data in creating |
| | | native output. The serializer |
| | | will add pad characters |
| | | to an output field to get it to |
| | | the value set |
| | | here as a minimum. |
| wrap_char | character | Indicates what character |
| | | is used to wrap data |
| | | contained in the field. |
| | | Fields wrapped in this |
| | | character will be |
| | | ignored by the parser. |
| wrap_char_type | Hexadecimal\| | |
| | Character\| | |
| | Default | |
| | Wrap | |
| | Character\| | |
| | None | |

FIG. 3 is a block diagram of an exemplary embodiment wherein the reverse process described with respect to FIG. 2 may be performed. In the serializing system 300 of FIG. 3, an appropriately configured XML input document 310 is input into a serializing engine 330 which has available the native document schema 320 extracted from the input process information. The serializer engine 330 assembles or reverse-parses the XML input 310 to the non-XML native data. The text writer 340 accepts the serialized data and performs the final conversion from serialized form into the native document output 350. The text writer 340 may be used to convert, for example, the UNICODE data into various encoding mechanisms such as UTF-8, ANSI, or MBCS. It is noteworthy that the annotations described in hereinabove apply, with only a few exceptions (explicitly noted in the table), to both Parsing and Serializing Engines.

As mentioned above, while exemplary embodiments of the invention have been described in connection with various computing devices and network architectures, the underlying concepts may be applied to any computing device or system in which it is desirable to implement an automated document conversion. Thus, the methods and systems of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by the invention.

The various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the signal processing services of the present invention, e.g., through the use of a data processing API or the like, are preferably implemented in a high level procedural or object oriented programming language to communicate with a computer. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the discussed invention. Additionally, any storage techniques used in connection with the invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated, especially as the number of wireless networked devices continues to proliferate. Therefore, the invention should not be limited to any single embodiment, but rather should be construed in breadth and scope in accordance with the appended claims.

1. A method of converting between a flat file and an XML file, comprising the steps of:
receiving the flat file in a native format;
translating characters of the native format into tokens;
parsing the tokens; and
producing an XML file by converting the first native format to an XML format with the use of at least one annotated schema comprising a model of a flat file.

2. The method of claim 1, wherein translating characters comprises generating tokens for one or more of a delimiter, a tag and a value.

3. The method of claim 1, wherein the at least one annotated schema comprises an XML schema with annotations.

4. The method of claim 1, wherein the at lest one annotated schema defines the flat file model.

5. The method of claim 1, wherein the native record type has one of a delimited format and a positional format.

6. The method of claim 5, wherein each format comprises an optional tag for identifying a record.

7. The method of claim 6, wherein the tag provides context for use with parsing the tokens.

8. The method of claim 1, further comprising converting the XML file to a second native file by serializing.

9. A machine-readable medium having machine-readable instructions for performing a method of converting between a flat file and an XML file, comprising the steps of:
receiving flat file in a native format;
translating characters of the native format input into tokens; and
parsing the tokens to produce an XML file by converting a first native format to an XML format with the use of at least one annotated schema comprising a model of a flat file format.

10. The machine-readable medium of claim 9, wherein the at least one annotated schema comprises XML schemas with annotations.

11. The machine-readable medium of claim 9, wherein the at lest one annotated schema defines the model.

12. The machine-readable medium of claim 9, wherein the model has one of a delimited format and a positional format.

13. The machine-readable medium of claim 12, wherein each format comprises an optional tag which helps identify a record.

14. The machine-readable medium of claim 13, wherein the tag provides context for use with parsing the tokens.

15. The machine-readable medium of claim 9, further comprising converting the XML file to a second native file by serializing.

16. A system for transferring files as part of a workflow comprising:
a processor, supporting hardware and software functions of the system;
an input device for receiving a flat file in a native format;
a text reader and tokenizer for reading and translating flat file characters of the native format input into tokens;
a parsing device which converts the tokens to characters in an XML file with the use of at least one annotated schema comprising a model of the native format; and
an output device for transmitting converted files;
wherein the processor executes instructions supporting file format conversion using the parser to convert files according to a workflow.

17. The system of claim 16, further comprising a serializer device which converts an XML file format back into a native format.

18. The system of claim 16, wherein the at least one annotated schema comprises an XML schema with annotations.

19. The system of claim 16, wherein the native format has one of a delimited format and a positional format.

20. The system of claim 19, wherein each format comprises an optional tag for identifying a record.
